(19) United States
(12) Patent Application Publication
(10) Pub. No.: US 2023/0286050 A1
(43) Pub. Date: Sep. 14, 2023

(54) METHOD OF SETTING MODELING CONDITION, ADDITIVE MANUFACTURING METHOD, ADDITIVE MANUFACTURING SYSTEM, AND PROGRAM

(71) Applicant: Kabushiki Kaisha Kobe Seiko Sho (Kobe Steel, Ltd.), Kobe-shi (JP)

(72) Inventors: Naoki MUKAI, Fujisawa-shi (JP); Shun IZUTANI, Fujisawa-shi (JP)

(73) Assignee: Kabushiki Kaisha Kobe Seiko Sho (Kobe Steel, Ltd.), Kobe-shi (JP)

(21) Appl. No.: 18/005,866

(22) PCT Filed: Aug. 25, 2021
(86) PCT No.: PCT/JP2021/031260

§ 371 Date: Jan. 18, 2023

(30) Foreign Application Priority Data
Sep. 25, 2020 (JP) 2020-161260

(51) Int. Cl. B22F 10/85; B22F 10/366; B22F 10/28

(52) U.S. Cl. CPC B22F 10/85; B22F 10/366; B22F 10/28; B22F 12/88

(57) ABSTRACT

The present invention has: a setting step for setting lamination patterns respectively for an outer edge portion and an inner portion of a shape indicated by shaping data; and an adjustment step for adjusting a forming sequence such that, during manufacturing when the lamination patterns are used to laminate and thereby form the outer edge portion and the inner portion, the height of the already laminated outer edge portion is higher than the height of the inner portion that is being newly laminated. In the lamination patterns, the orientation of the heat source when a region positioned at a boundary with the outer edge portion is formed is set so as to be inclined at a prescribed angle toward the outer edge portion in a plan perpendicular to a movement direction of the heat source.

### TECHNICAL FIELD

The present invention relates to a modeling condition setting method, an additive manufacturing method, an additive manufacturing system, and a program.

### BACKGROUND ART

In recent years, there is an increasing need of part manufacturing by modeling using a 3D printer, and research and development are being conducted to achieve practical use of modeling using metal materials. Many of 3D printers that perform modeling with metal materials model an additively manufactured object by laminating weld metal which is formed by melting and solidifying metal powder or metal wires using a heat source such as a laser, an electron beam, or arc.

For example, PTL 1 discloses a method as a technique to produce a rotational member, such as an impeller or a rotor, provided in a fluid machine such as a pump or a compressor, the method including: modeling a model section in a base component serving as a hub, and subsequently, forming a blade by cutting the model section.

### CITATION LIST

### Patent Literature

PTL 1: WO 2016/149774

### SUMMARY OF INVENTION

### Technical Problem

A member having a complicated shape can be disassembled into element shapes in a simple configuration. The simple element shapes include, for example, a cylindrical shape, a solid rectangular prism shape, a solid circular prism shape, and a thin plate shape. Also, in such simple element shapes, workability can be classified according to the position such as the outer edge portion and the inner portion as the components. In relation to this, the details of control to reduce welding defect vary with the position. Specifically, when additive manufacturing is performed, it is necessary to adjust a modeling condition for forming the shape of an object to be modeled according to the position (corresponding to the later-described position type) of the shape.

In view of the above-mentioned problem, it is an object of the present invention to enable appropriate setting of modeling conditions according to the regions constituting an additively manufactured object and the formation situation in the periphery.

### Solution to Problem

In order to solve the above-mentioned problem, the present invention has the following configuration.
(1) A modeling condition setting method for performing additive manufacturing of an object using a directional heat source based on model shape data of the object, the method comprising:
a setting step for setting a lamination pattern for each of an outer edge portion and an inner portion in a shape indicated by the model shape data; and
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

In addition, the present invention has the following configuration as another embodiment.
(2) An additive manufacturing method for performing additive manufacturing of an object using a directional heat source based on model shape data of the object, the additive manufacturing method comprising:
a setting step for setting a lamination pattern for each of an outer edge portion and an inner portion in a shape indicated by the model shape data;
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated; and
a control step for causing a modeling means to perform additive manufacturing of the object based on the lamination pattern set in the setting step and the order of formation adjusted in the adjustment step,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

In addition, the present invention has the following configuration as another embodiment.
(3) An additive manufacturing system for performing additive manufacturing of an object using a directional heat source based on model shape data of the object, the additive manufacturing system comprising:
a setting means to set a lamination pattern for each of an outer edge portion and an inner portion in a shape indicated by the model shape data;
an adjustment means to adjust an order of formation when each of the outer edge portion and the inner portion is formed by lamination using the lamination pattern set by the setting means so that at a time of modeling, a height of the outer edge portion already laminated is higher than a height of the inner portion which is to be newly laminated; and
a modeling means to perform additive manufacturing of the object based on the lamination pattern set by the setting means and the order of formation adjusted by the adjustment means,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

In addition, the present invention has the following configuration as another embodiment.
(4) A program for causing a computer to execute:
a setting step for setting a lamination pattern for each of an outer edge portion and an inner portion in a shape indicated by model shape data of an object; and
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated,
wherein in the lamination pattern, an orientation of a heat source when forming a region positioned at a boundary with the outer edge portion is set to be inclined at a predetermined angle with respect to the outer edge portion in a plane perpendicular to a direction of movement of the heat source.

### Advantageous Effects of Invention

The present invention makes it possible to appropriately set modeling conditions according to the regions constituting an additively manufactured object and the formation situation in the periphery.

### BRIEF DESCRIPTION OF DRAWINGS

FIG. 1 is a schematic illustration showing an example of the entire configuration of a system according to an embodiment of the present invention.

FIG. 2 is a block diagram showing an example of a functional configuration of a modeling control device according to an embodiment of the present invention.

FIG. 3 is a flowchart showing the entire process of the modeling control device according to an embodiment of the present invention.

FIG. 4 is a conceptual illustration for explaining disassembly to element shapes according to an embodiment of the present invention.

FIG. 5 is a schematic table showing a configuration example of a lamination pattern DB according to an embodiment of the present invention.

FIG. 6A is a schematic illustration for explaining a formation path according to an embodiment of the present invention.

FIG. 6B is a schematic illustration for explaining a formation path according to an embodiment of the present invention.

FIG. 6C is a schematic illustration for explaining a formation path according to an embodiment of the present invention.

FIG. 7A is a schematic illustration for explaining a formation path according to an embodiment of the present invention.

FIG. 7B is a schematic illustration for explaining a formation path according to an embodiment of the present invention.

FIG. 7C is a schematic illustration for explaining a formation path according to an embodiment of the present invention.

FIG. 8A is a schematic view for explaining torch control according to an embodiment of the present invention.

FIG. 8B is a schematic view for explaining torch control according to an embodiment of the present invention.

FIG. 9 is a schematic view for explaining pass height according to an embodiment of the present invention.

FIG. 10 is a schematic view for explaining a flow to determine an order of formation according to an embodiment of the present invention.

FIG. 11A is a schematic view for explaining a flow to determine an order of formation according to an embodiment of the present invention.

FIG. 11B is a schematic view for explaining a flow to determine an order of formation according to an embodiment of the present invention.

FIG. 11C is a schematic view for explaining a flow to determine an order of formation according to an embodiment of the present invention.

FIG. 11D is a schematic view for explaining a flow to determine an order of formation according to an embodiment of the present invention.

FIG. 12 is a flowchart of a formation order determination process according to an embodiment of the present invention.

FIG. 13A is a schematic illustration for explaining crossing of passes according to an embodiment of the present invention.

FIG. 13B is a schematic illustration for explaining crossing of passes according to an embodiment of the present invention.

FIG. 14A is a schematic illustration for explaining sharing of a pass according to an embodiment of the present invention.

FIG. 14B is a schematic illustration for explaining sharing of a pass according to an embodiment of the present invention.

FIG. 14C is a schematic illustration for explaining sharing of a pass according to an embodiment of the present invention.

FIG. 15 is a schematic view for explaining a flow to determine an order of formation according to an embodiment of the present invention.

FIG. 16 is a flowchart of a formation order determination process according to a second embodiment of the present invention.

FIG. 17 is a schematic view for explaining a flow to determine an order of formation according to the second embodiment of the present invention.

### DESCRIPTION OF EMBODIMENTS

Hereinafter, an embodiment for implementing the present invention will be described with reference to the drawings. Note that the embodiment described below is an embodiment for explaining the present invention, and it is not intended that the present invention be interpreted in a limited sense. All the configurations described in the embodiments are not necessarily required configurations to solve the problem of the present invention. In the drawings, correspondence relationships are shown by labeling the same components with the same reference number.

### First Embodiment

Hereinafter, a first embodiment of the present invention will be described.

### [System Configuration]

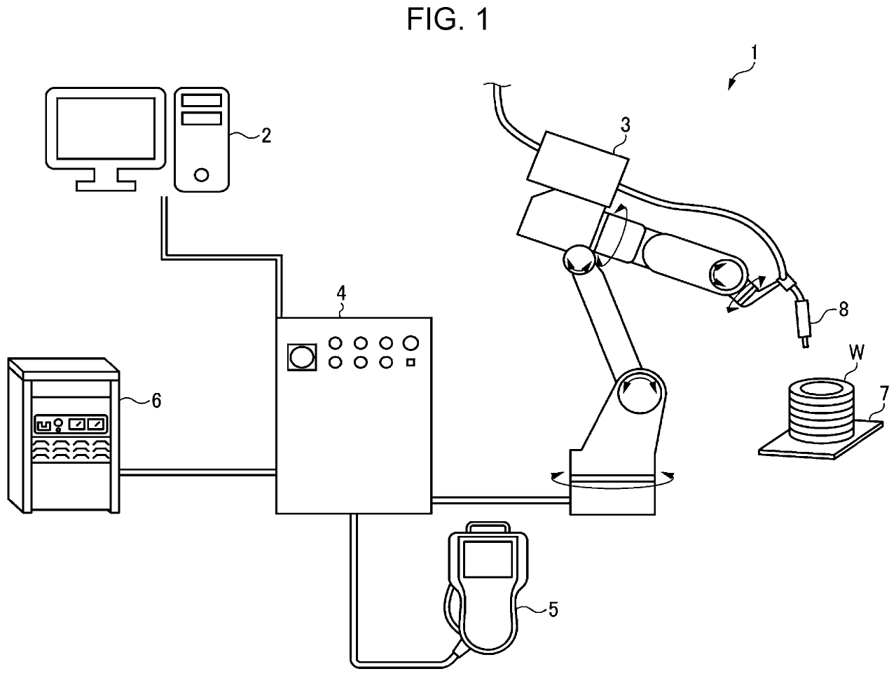

Hereinafter, a first embodiment of the present invention will be described in detail with reference to the drawings. FIG. 1 is a schematic illustration showing an example of the entire configuration of an additive manufacturing system to which an additive manufacturing method according to the present invention is applicable.

An additive manufacturing system 1 according to this embodiment is configured to include a modeling control device 2, a manipulator 3, a manipulator control device 4, a controller 5, and a heat source control device 6.

The manipulator control device 4 controls the manipulator 3, the heat source control device 6, and an unillustrated filler metal supply unit that supplies filler metal (hereinafter also referred to as a wire) to the manipulator 3. The controller 5 is a unit to input instructions of an operator of the additive manufacturing system 1, and allows an arbitrary operation to be input to the manipulator control device 4.

The manipulator 3 is, for example, an articulated robot, and in a torch 8 provided in its leading end shaft, a wire is supported to allow continuous supply. The torch 8 is held in a state where a wire projects from the leading end. The position and posture of the torch 8 is three-dimensionally arbitrarily settable in a range of degree of freedom of the robot arms included in the manipulator 3. The manipulator 3 preferably has a degree of freedom of six or more axes, and it is preferable that the axial direction of a heat source at the leading end be arbitrarily settable. FIG. 1 shows an example of the manipulator 3 having a degree of freedom of six axes as illustrated by arrows. In addition to an articulated robot with four or more axes, the form of the manipulator 3 may be a robot provided with an angle adjustment mechanism in orthogonal axes with two or more axes.

The torch 8 has an unillustrated shield nozzle through which a shielding gas is supplied. The shielding gas shields the atmosphere, and prevents poor weld by protecting against oxidation, nitriding of molten metal during a weld. The arc welding method used in this embodiment may be either one consumable electrode TIG (Tungsten Inert Gas) welding such as shielded arc welding and carbon dioxide arc welding, or non-consumable electrode welding such as plasma arc welding, and is selected as appropriate according to the additively manufactured object to be modeled. In this embodiment, a description is given using gas metal arc welding as an example.

In the manipulator 3, when the arc welding method is consumable electrode type, a contact chip is arranged inside the shield nozzle, and a wire supplied with a current is held in the contact chip. The torch 8 generates an are from the leading end of the wire in a shielding gas atmosphere while holding the wire. The wire is supplied to the torch 8 from an unillustrated filler metal supply unit by an unillustrated feed mechanism mounted on a robot arm or the like. When a continuously supplied wire is molten and solidified while the torch 8 is being moved, a linear bead, which is a molten solidified body of the wire, is formed on a base 7. With beads being laminated, an additively manufactured object W to be achieved is modeled.

Note that the heat source that causes the wire to melt is not limited to the above-mentioned arc. A heat source based on other methods may be used, such as a heating method using both an arc and a laser, a heating method using plasma, and a heating method using an electron beam and a laser. When heating is performed with an electron beam or a laser, the amount of heating can be controlled further finely, which can contribute to further improvement of quality of a laminated structure by maintaining the state of the bead more appropriately. Also, the material for the wire is not particularly limited, and the type of wire to be used may vary according to the characteristics of the additively manufactured object W, for example, mild steel, high tensile strength steel, aluminum, aluminum alloy, nickel, and nickel-based alloy.

The manipulator control device 4 drives the manipulator 3 and the heat source control device 6 based on a predetermined program group provided by the modeling control device 2, and models the additively manufactured object W on the base 7. Specifically, the manipulator 3 moves the torch 8 while melting the wire with an arc by a command from the manipulator control device 4. The heat source control device 6 is a welding power supply to supply electric power required for welding by the manipulator 3. The heat source control device 6 can change the current or voltage when the bead is formed. In this embodiment, a configuration using a planar base 7 is shown; however, the configuration is not limited to this. For example, a configuration may be adopted in which the base 7 is formed in a circular prism shape, and beads are formed on the outer circumference of the lateral surface. The coordinate system in the model shape data according to this embodiment is associated with the coordinate system on the base 7 on which the additively manufactured object W is modeled, and for example, three axes of the coordinate system may be set so that position in three dimensions is defined with an arbitrary position as the origin. When the base 7 is formed in a circular prism shape, a cylindrical coordinate system may be set, and depending on circumstances, a spherical coordinate system may be set. Note that a coordinate component (hereinafter also referred to as a “coordinate axis”) may be set arbitrarily depending on the type of coordinate system, such as a rectangular coordinate system, a cylindrical coordinate system, and a spherical coordinate system. For example, three axes of a rectangular coordinate system are respectively denoted by X-axis, Y-axis, Z-axis as three straight lines perpendicular to each other in space.

The modeling control device 2 may be an information processing device such as a PC (Personal Computer), for example. The later-described functions of the modeling control device 2 may be implemented by an unillustrated control unit reading and executing a program stored in an unillustrated storage device, the program having a function according to this embodiment. The storage device may include a RAM (Random Access Memory) which is a volatile memory area, and a ROM (Read Only Memory) or a HDD (Hard Disk Drive) which is a non-volatile memory area. In addition, as the control unit, a CPU (Central Processing Unit) or a dedicated circuit may be used.

### [Functional Configuration]

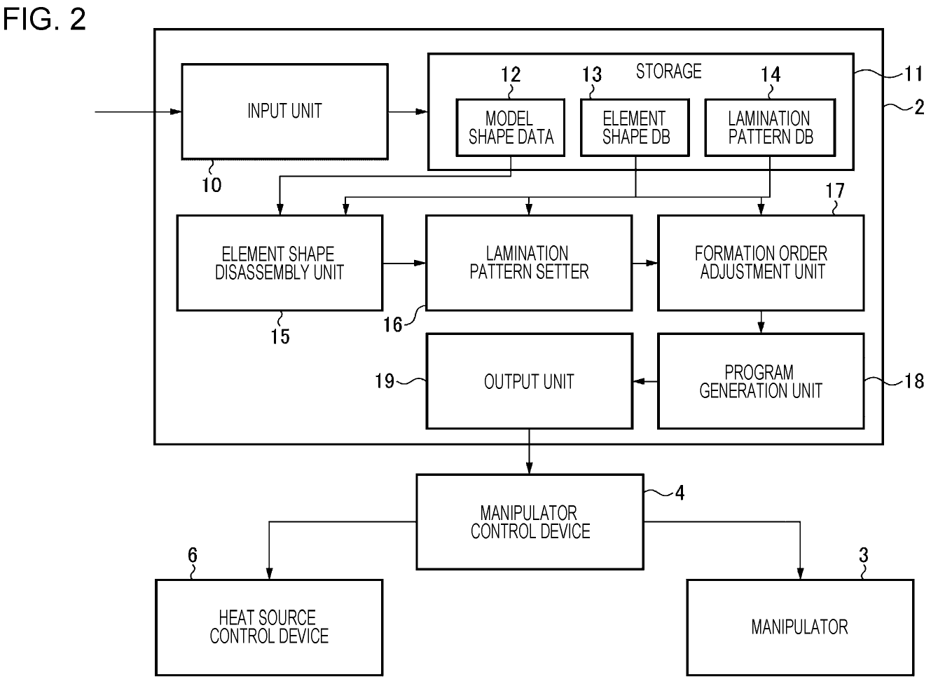

FIG. 2 is a block diagram mainly showing the functional configuration of the modeling control device 2 according to this embodiment. The modeling control device 2 is configured to include an input unit 10, a storage 11, an element shape disassembly unit 15, a lamination pattern setting unit 16, a formation order adjustment unit 17, a program generation unit 18, and an output unit 19. The input unit 10 obtains various information from the outside via an unillustrated network, for example. The information obtained here is, for example, design data (hereinafter referred to as “model shape data”), such as CAD/CAM data, of an object for which additive manufacturing is performed. The details of the various information used in this embodiment will be described below. The model shape data may be input from an unillustrated external device connected to allow communication, or may be generated on the modeling control device 2 using an unillustrated predetermined application.

The storage 11 stores various information obtained by the input unit 10. In addition, the storage 11 holds and manages the database (DB) of element shapes and lamination patterns according to this embodiment. The details of the element shapes and lamination patterns will be described below.

The element shape disassembly unit 15 extracts predetermined element shapes from the shape of an additively manufactured object indicated by the model shape data, thereby disassembling the shape of an additively manufactured object into a plurality of element shapes. In other words, in this embodiment, the shape of one additively manufactured object is treated as a complicated shape constituted by a plurality of element shapes.

The lamination pattern setting unit 16 assigns and sets a lamination pattern predetermined in a lamination pattern DB 14 to each of a plurality of element shapes disassembled by the element shape disassembly unit 15. More specifically, the lamination pattern setting unit 16 sets a lamination pattern for modeling an element shape for the beads constituting the element shape.

The formation order adjustment unit 17 adjusts the order in which beads are formed (hereinafter also referred to as “laminated”) for each of a plurality of element shapes based on the lamination pattern set by the lamination pattern setting unit 16.

The program generation unit 18 generates a program group for modeling the additively manufactured object W based on the order of formation adjusted by the formation order adjustment unit 17. For example, one program may correspond to one bead included in the additively manufactured object W. The program group generated here is processed, and executed by the manipulator control device 4, thus the manipulator 3 and the heat source control device 6 are controlled. Note that the type and specifications of program group processable by the manipulator control device 4 are not particularly limited, and the specifications of the manipulator 3 and the heat source control device 6 required for generation of a program group, and the specifications of wires are assumed to be held in advance.

The output unit 19 outputs the program group generated by the program generation unit 18 to the manipulator control device 4. In addition, the output unit 19 may be configured to output results of processing on model shape data using an unillustrated output device, such as a display included in the modeling control device 2.

### [Entire Process]

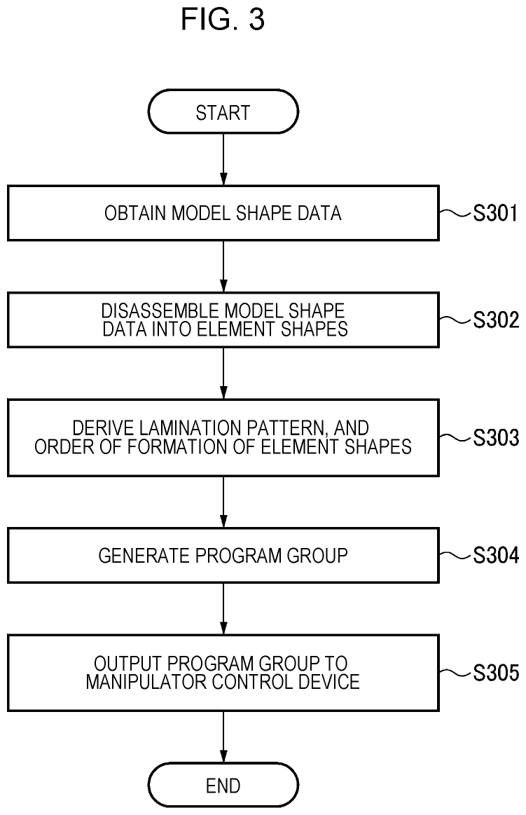

FIG. 3 is a flowchart showing the flow of the entire process performed by the modeling control device according to this embodiment. This process may be implemented, for example, by a control unit such as a CPU reading and executing a program from an unillustrated storage device to achieve each unit shown in FIG. 2, the control unit being included in the modeling control device 2. Here, in order to simplify a description, the agents of the process are collectively referred to as the modeling control device 2.

In S301, the modeling control device 2 obtains the model shape data of the additively manufactured object W to be modeled. As described above, the model shape data may be obtained from the outside, or may be generated using an unillustrated application included in the modeling control device 2, and obtained.

In S302, the modeling control device 2 refers to the element shape DB 13 predefined and held in the storage 11, and disassembles the shape indicated by the model shape data obtained in S301 into a plurality of element shapes.

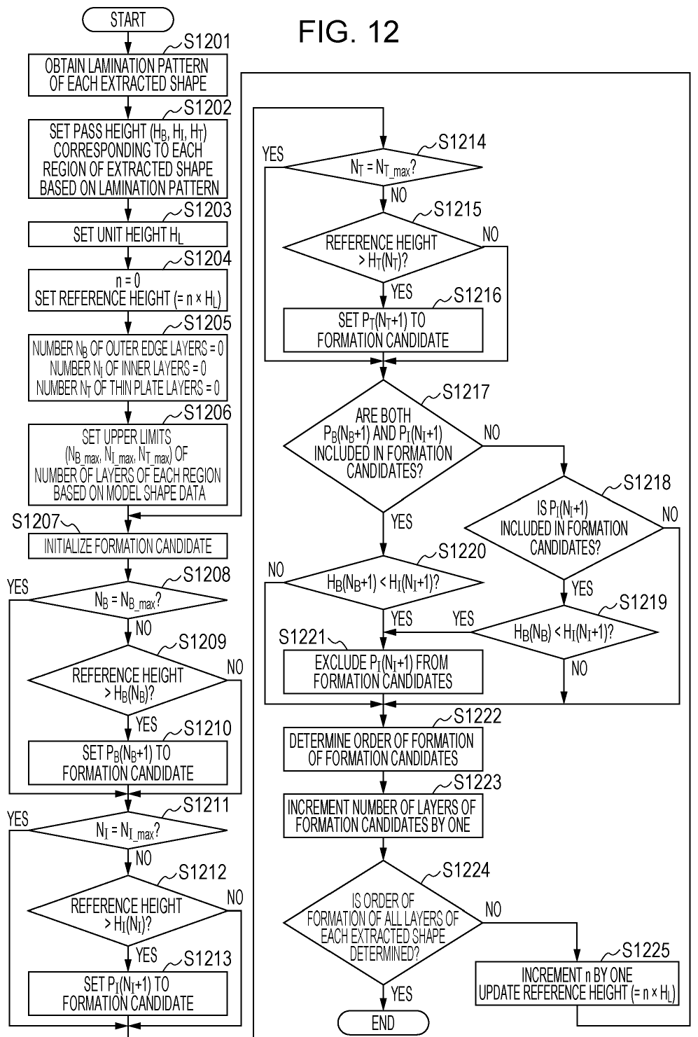

In S303, the modeling control device 2 refers to the lamination pattern DB 14 for each of the plurality of element shapes extracted in S302 to derive a lamination pattern. In addition, the modeling control device 2 derives an order of formation for modeling the plurality of element shapes. The details of the process will be described below with reference to FIG. 12.

In S304, the modeling control device 2 generates a program group to be used by the manipulator control device 4 based on the lamination pattern and the order of formation derived in S303.

In S305, the modeling control device 2 outputs the program group generated in S304 to the manipulator control device 4. The process flow is then completed.

### [Disassembly to Element Shapes]

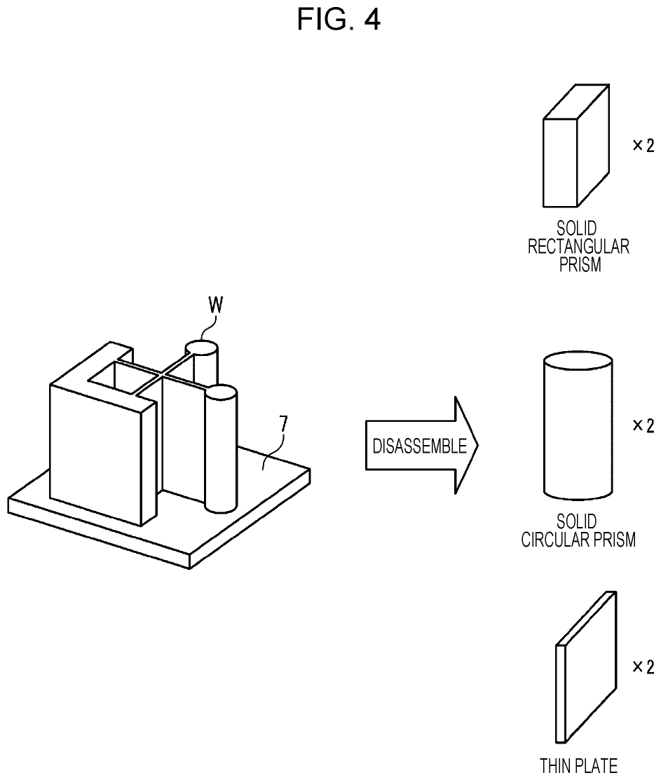

FIG. 4 is a conceptual illustration for explaining an example of disassembly of the shape of the additively manufactured object W indicated by the model shape data into a plurality of element shapes. The shape of the additively manufactured object W to be modeled is shown on the base 7. The shape of the additively manufactured object W can be disassembled into two solid rectangular prisms, two solid circular prisms, and two thin plates. Note that the above disassembly is an example, and disassembly into other shapes may be made according to predetermined element shapes.

Disassembly into element shapes may be implemented, for example, by the modeling control device 2 performing pattern matching based on the element shape DB 13. Alternatively, a configuration may be adopted in which an operator of the modeling control device 2 specifies or assigns the element shapes to be used for disassembly. In addition, a configuration may be adopted in which an operator corrects the disassembly performed by the modeling control device 2.

In some cases, a solid rectangular prism and/or a solid circular prism are necessary to support the load of a heavy object which is placed above the additively manufactured object W, for example. Also, a thin plate may be necessary, for example, when water-tightness is required to perform cooling by flowing fluid between the solid rectangular prisms and the thin plates shown in FIG. 4, or when the function as a support rib is required to prevent a solid rectangular prism and a solid circular prism from falling sideways. In other words, the additively manufactured object W is formed as a complicated shape in a combination of a plurality of element shapes, and the function required for each element shape varies depending on the combination. Thus, additive manufacturing according to each region needs to be performed.

### [Database]

In this embodiment, as shown in FIG. 2, the element shape DB 13 and the lamination pattern DB 14 are used. The element shape DB 13 and the lamination pattern DB 14 are predetermined, and held and managed in the storage 11. In this embodiment, the additively manufactured object W to be modeled is treated as an object which is formed in a combination of a plurality of simple shapes (hereinafter referred to as “element shape”). Thus, the element shape forming the additively manufactured object W is defined in advance, and managed in the element shape DB 13. As the element shape, a solid rectangular prism, a thin-walled hollow rectangular prism, a thick-walled hollow rectangular prism, a solid circular prism, a thin-walled hollow circular prism, a thick-walled hollow circular prism, a thin plate, and a solid sector prism may be used, but other shapes may be included. Even with the same shape, more detailed classification may be defined according to the size of a model. The size of a model includes, for example, height, width, thickness, and aspect ratio.

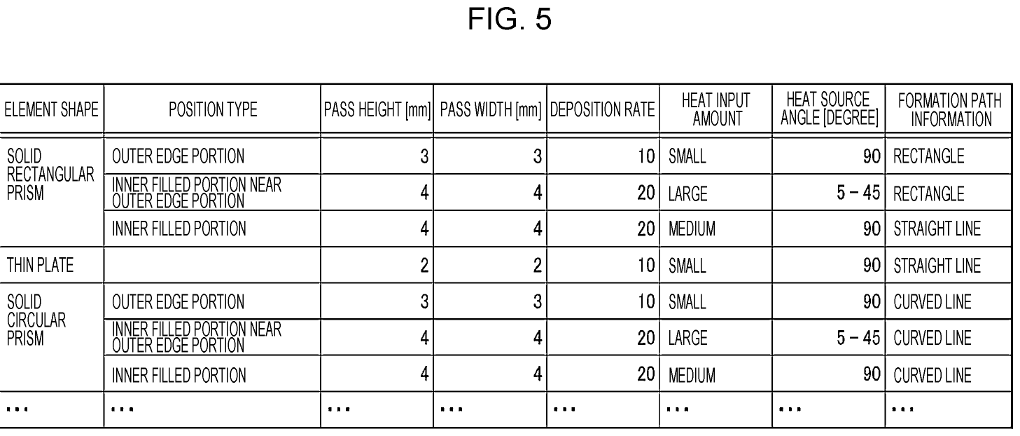

The lamination pattern DB 14 is a database in which conditions for performing additive manufacturing are defined for each of the element shapes defined in the element shape DB 13. FIG. 5 shows a configuration example of the lamination pattern DB 14. The lamination pattern DB 14 includes element shape, position type, pass height, pass width, deposition rate, heat input amount, heat source angle, and formation path information. The element shape indicates the type of element shape, defined corresponding to the element shape DB 13. The position type indicates the type of region included in the element shape. As an example, a description is given assuming that a solid prism consists of regions of an outer edge portion, an inner filled portion in the vicinity of the outer edge portion, and an inner filled portion; however, without being limited to this, a further detailed classification may be used. The vicinity of the outer edge portion may be, for example, one bead adjacent to the outer edge portion, or may indicate a range exceeding one bead, and is not particularly limited.

The pass height indicates the height per pass of bead when a corresponding position type is formed. The pass width indicates the width per pass of bead when a corresponding position type is formed. Note that it is assumed that one bead is formed by one pass. The deposition rate indicates the weight of wire melted per unit time when bead is formed. As the deposition rate, for example, feed rate, that is, wire feed rate per unit time may be used. The heat input amount indicates the amount of heat input by a heat source when bead is formed. The heat input amount is expressed in terms of three levels: large, medium, small, but may be expressed by level number or numerical value. The heat source angle indicates the angle of a heat source when bead is formed. In this embodiment, the heat source angle is the inclination angle of a directional heat source, and indicates the angle formed by the surface forming a bead and the heat source direction in a plane perpendicular to the direction of movement of the heat source. The angle of the heat source can be set arbitrarily, and is not necessarily equal to the inclination angle of the torch 8. Regarding the method of setting a heat source angle, for example, when the arc welding method is used, a heat source angle is settable using a magnetic generator, and when the laser welding method is used, a heat source angle is settable using a mirror. The formation path information includes the later-described pattern of formation path of bead, and its start point position, end point position, and further includes a path of movement to the start point position of the next pass.

In various types of data defined in the lamination pattern DB 14, for the outer edge portion of element shape, a condition of low heat input amount is set for shape reproducibility. In contrast, for the inner filled portion, a condition of high deposition rate is set in consideration of construction efficiency. In addition, for the inner filled portion in the vicinity of the outer edge portion, in order to sufficiently supply heat to a bead end, and reduce the occurrence of a defect such as lack of fusion, a condition is set such that the heat source angle is inclined by a certain angle from a downward direction (90 degrees). In the example of FIG. 5, a set value of 5 to 45 degrees is used; however, a range of 10 to 35 degrees is more preferable, and a range of 10 to 25 degrees is further preferable.

When a lamination pattern is set, deposition conditions for forming an actual bead can be determined from the specifications of the manipulator 3 and the heat source control device 6, and the type of the wire. For example, in a lamination method by arc, the amount of welding is correlated with the feed rate and the diameter of the wire. The heat input amount is correlated with the current and the voltage supplied from the heat source control device 6, and the distance between chip and base. The heat source angle is correlated with the torch angle, the current and the voltage supplied from the heat source control device 6, and the distance between chip and base. Also, in a lamination method by a laser, the heat source angle is correlated with the incident angle of the laser, the focal length of an optical system, and the relative distance between an object and a focus position. Note that various conditions for modeling the additively manufactured object W, such as a lamination pattern and a deposition condition, are also collectively referred to as a modeling condition.

### [Formation Path Information]

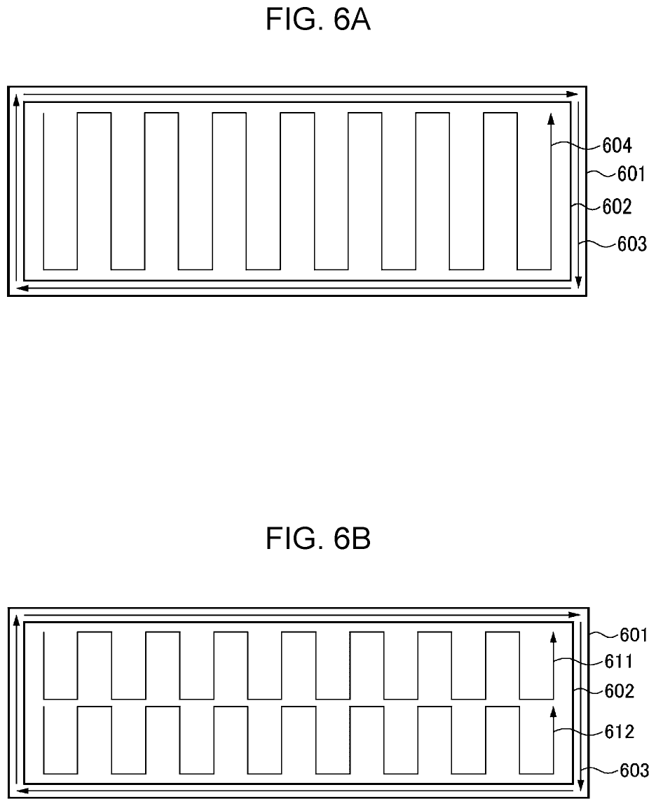

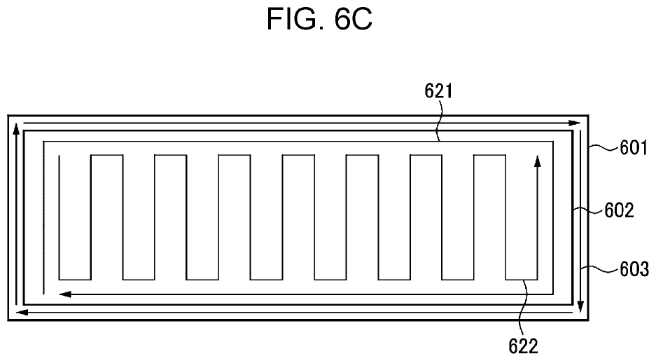

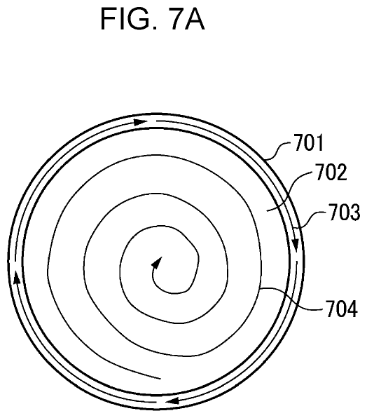

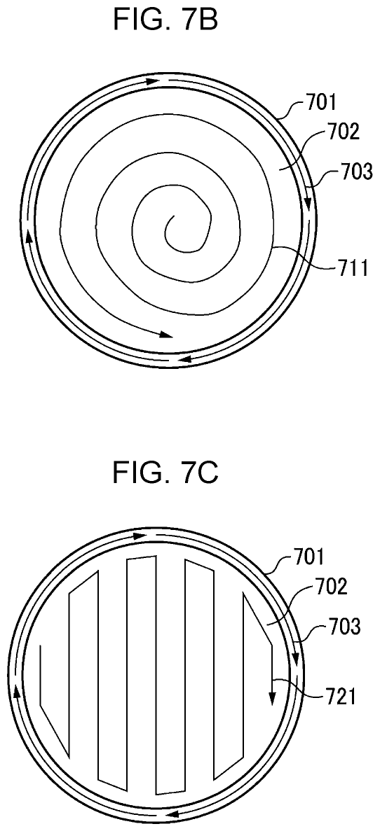

FIG. 6A to FIG. 6C, FIG. 7A to FIG. 7C show an example of a path (formation path of bead) of movement of the torch 8 indicated by formation path information according to this embodiment. FIG. 6A to FIG. 6C show an example of formation path information corresponding to a rectangular prism. FIG. 6A shows a path 603 for forming an outer edge portion 601 by four passes, and a path 604 for forming an inner filled portion 602 by one pass (five passes in total). FIG. 6B shows the path 603 for forming the outer edge portion 601 by four passes, and paths 611, 612 for forming the inner filled portion 602 by two passes (six passes in total). FIG. 6C shows the path 603 for forming the outer edge portion 601 by four passes, a path 621 for forming the inner filled portion in the vicinity of the outer edge portion by one pass, and a path 622 for forming the inner filled portion by one pass (six passes in total).

FIG. 7A to FIG. 7C show an example of formation path information corresponding to a circular prism. FIG. 7A shows a path 703 for forming an outer edge portion 701 clockwise by four passes, and a path 704 for forming an inner filled portion 702 clockwise by one pass (five passes in total). FIG. 7B shows the path 703 for forming the outer edge portion 701 clockwise by four passes, and a path 711 for forming the inner filled portion 702 counterclockwise by one pass (five passes in total). FIG. 7C shows the path 703 for forming the outer edge portion 701 clockwise by four passes, and a path 721 for forming the inner filled portion 702 by one pass with line segments (five passes in total). Note that the paths of movement indicated by formation path information is not limited to these, and other paths may be used. For example, a configuration may be adopted in which the outer edge portion is formed by one pass, or a configuration may be adopted in which a deposition condition is changed during one pass.

In this embodiment, in a solid prism, it is assumed that the outer edge portion is formed first, and subsequently, the inner filled portion is formed. Although not shown in FIG. 6A to FIG. 6C, FIG. 7A to FIG. 7C, such formation path information may be used, that indicates that weaving be performed as appropriate when bead is formed to reduce welding defect.

### [Torch Control]

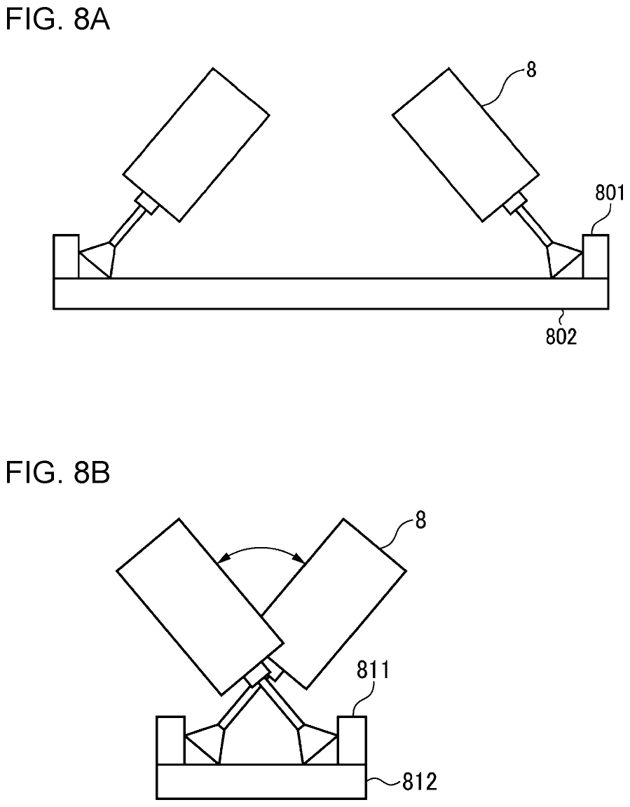

FIG. 8A and FIG. 8B are illustrations for explaining the control of the orientation of the torch 8 according to this embodiment. In order to simplify a description, it is assumed that the inclination angle (torch angle) of the torch 8 and the heat source angle are the same in the description. A case is discussed where a bead corresponding to the inner filled portion in the vicinity of the outer edge portion of element shape is formed. In this case, in order to sufficiently supply heat to a bead end, and reduce the occurrence of a defect of lack of fusion, the torch angle is inclined at a certain angle. FIG. 8A shows an example in which when the distance between outer edge portions 801 is greater than or equal to a certain value, the inclination angle of the torch 8 is inclined at approximately 45 degrees in the corners of the angles formed by the outer edge portions 801 and a planar portion 802. FIG. 8B shows an example in which when the distance between outer edge portions 811 is less than or equal to a certain value (valley portion), weaving is performed so as to move the torch 8 in a movement direction while inclining the torch 8 at a certain angle instead of translating the torch 8 in a movement direction. Thus, control is performed so as to supply sufficient heat to the corners of the angles formed by the outer edge portions 811 and a planar portion 812.

### [Pass Height]

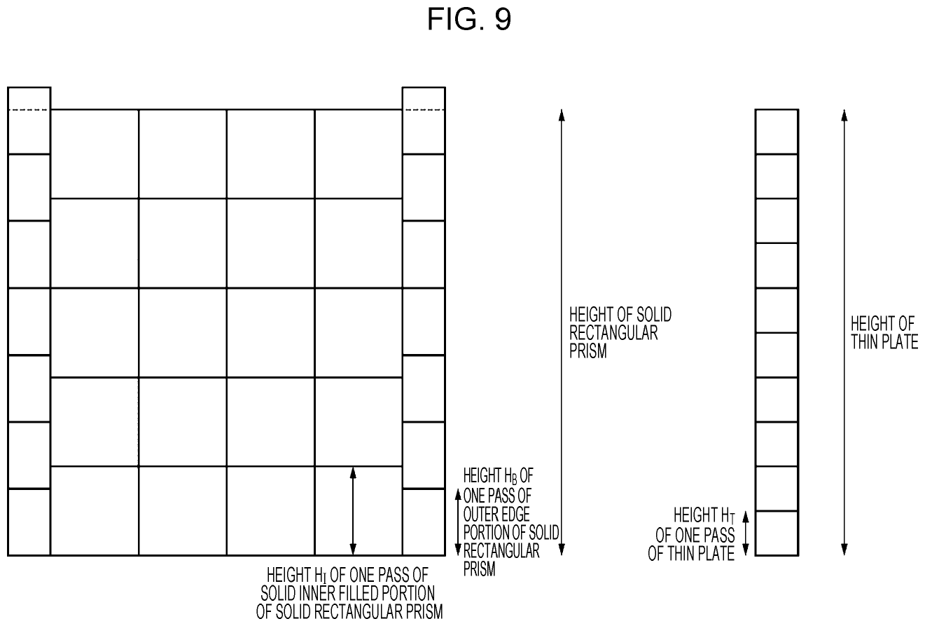

FIG. 9 is a view for explaining pass height of the additively manufactured object W according to this embodiment. Herein, a description will be given using the cross-section of a solid rectangular prism and a thin plate as an example. Herein, a description will be given assuming that the height direction is the lamination direction.

The solid rectangular prism can be divided into an outer edge portion and an inner filled portion. In this situation, as shown in FIG. 5, the height per pass when forming a bead is defined in advance according to the position type as a lamination pattern. In this embodiment, the pass height of the inner filled portion of the solid rectangular prism is denoted by H_{I}, and the pass height of the outer edge portion is denoted by H_{B}. Similarly, the pass height per pass of the thin plate is denoted by Hr.

In this embodiment, the pass heights are defined so that the following relationships hold therebetween.

H_{I}≥H_{B}

H_{I}≥H_{T}

This is because to increase the range formed by one pass in emphasis on efficiency (construction efficiency) of formation in the inner filled portion of the solid rectangular prism. In contrast, for the outer edge portion of the solid rectangular prism and the thin plate, a pass height lower than that of the inner filled portion is set to improve the accuracy of formation in emphasis on shape reproducibility and reduction in the occurrence of a welding defect. As an example, setting can be made so that the relationship of H_{B}:H_{I}:H_{T}=3:4:2 holds.

In these conditions, a plurality of beads are laminated in a lamination direction, thus the additively manufactured object W is modeled. In the case of the example of FIG. 9, in order to model the solid rectangular prism, seven layers are laminated in the outer edge portion, and five layers are laminated in the inner filled portion. Similarly, in order to model the thin plate, 10 layers are laminated. In the example of FIG. 9, as a result of lamination, part of the outer edge portion of the solid rectangular prism protrudes from the shape of the solid rectangular prism to be achieved, but this may be processed by performing a cutting process after the modeling. In addition, a configuration may be adopted in which for the uppermost layer, a control parameter different from that for other layers is used to achieve a target shape.

The example of FIG. 9 shows an instance in which the inner filled portion of the solid rectangular prism is formed with the width of 4 passes in a width direction; however, the embodiment is not limited to this. In addition, an instance is shown in which a thin plate is formed with the width of one pass in a width direction; however, the embodiment is not limited to this. For example, a region with a predetermined thickness (width) or less may be treated as a thin-walled section (for example, a thin plate), and a region with a thickness greater than the predetermined thickness may be treated as a thick-walled section.

In the example of FIG. 9, it is assumed that the base 7 (surface for forming the additively manufactured object W) is horizontal, and each layer is shown in a horizontal state. However, without being limited to this configuration, the configuration of a lamination direction and layers (layer plane) may be changed according to the shape of the base 7. For example, as described above, when the base 7 has a circular prism shape, and the additively manufactured object W is modeled while rotating the base 7, the configuration of the lamination direction and the layer plane may be defined according to the rotational surface (curved surface) of the base 7. In this case, the layer plane (cross-sectional direction) is configured to be parallel to the lamination surface of the base 7.

### [Formation Order Determination]

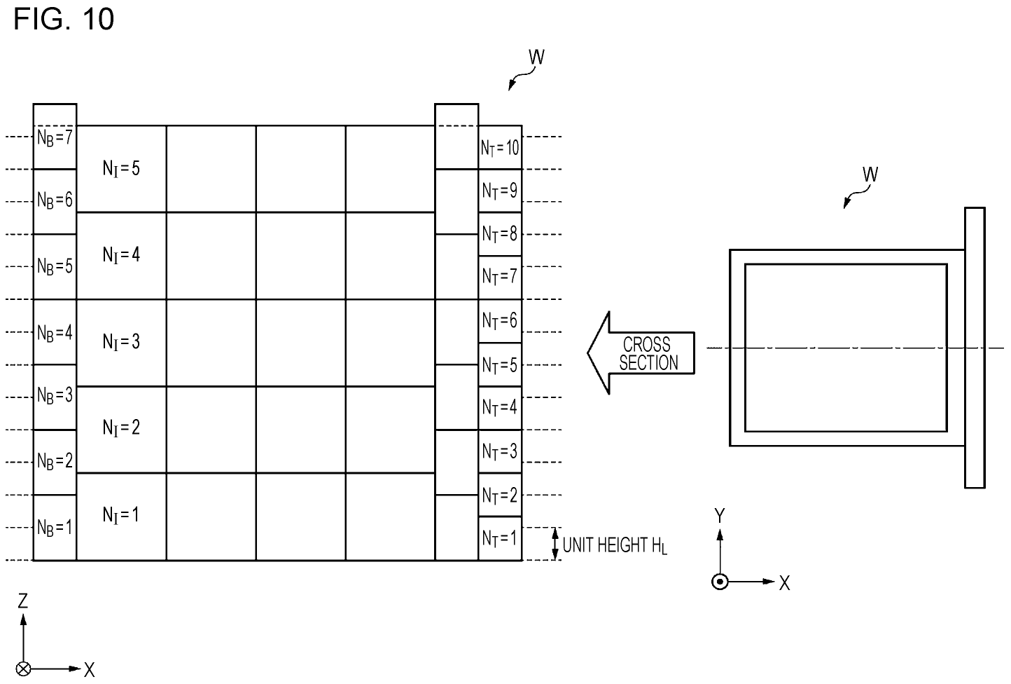

FIG. 10 is a schematic view for explaining a concept for determining the order of formation of layers for the plurality of element shapes constituting the additively manufactured object W. Here, a description is given using the additively manufactured object W constituted by a thin plate and a solid rectangular prism as an example. In FIG. 10, a cross-sectional view taken along a dashed-dotted line is shown. Here, the outer edge portion and the inner filled portion of the solid rectangular prism, and the thin plate will be described using the same configuration as the configuration shown in FIG. 9 as an example. In the following drawings, three-dimensional space and three axes defining the space are associated with each other. The coordinate axes are denoted by X-axis, Y-axis, Z-axis. In the lamination direction indicated by the Z-axis, the layers of each element shape are each shown by a variable N from the lower layer in order. Let N_{B} denote the number of layers of the outer edge portion, N_{I} denote the number of layers of the inner filled portion, and N_{T} denote the number of layers of the thin plate.

In this embodiment, unit height H_{L} is used as a reference when determining the order of formation of beads. The unit height H_{L} is assumed to be defined in advance. The H_{L} is set to a value equal to or less than the minimum of the pass heights of the element shapes. Specifically, in the example of FIG. 10, H_{B}, H_{I}, H_{T}≥H_{L}, where H_{B} is the pass height of the outer edge portion of the solid rectangular prism, H_{I} is the pass height of the inner filled portion, and H_{T} is the pass height of the thin plate.

For example, the relationship between the heights can be defined as follows:

aH_{L}=bH_{B}=cH_{I}
a≠c, b≠c, a>c, b>c, and a≥b
a, b, c: positive integers,
where c is preferably 1 to 5, and more preferably 1 to 3. In addition, a/b is preferably an integer less than or equal to 3, and more preferably 1 or 2. In the plurality of element shapes constituting the additively manufactured object W, it is preferable that a, b, c, H_{B}, H_{I} be set in common.

Furthermore, the relationship between the heights is preferably defined as follows:

H_{T}=H_{B}/d
d: positive integer

In other words, H_{T} is a fraction obtained by dividing H_{B} by an integer. In this situation, d is preferably less than or equal to 3, and more preferably 1.

In this embodiment, the order of formation of each element shape is determined in terms of the unit height H_{L}. For each element shape, the layer of a region where a lamination height does not reach a level is extracted as a formation candidate using the unit height H_{L} of interest as a reference. The lamination height here indicates the height attained by a plurality of beads as a result of laminated beads. Then, whether the formation candidate is appropriate as a layer to be formed is determined by comparison between the lamination heights when the layers of regions extracted as the formation candidates are formed. In this embodiment, in the case where the formation candidate includes a certain layer of the inner filled portion, and the already attained lamination height of the outer edge portion is exceeded by the lamination height of the inner filled portion as a result of forming the layer, formation of the layer of the inner filled portion is halted.

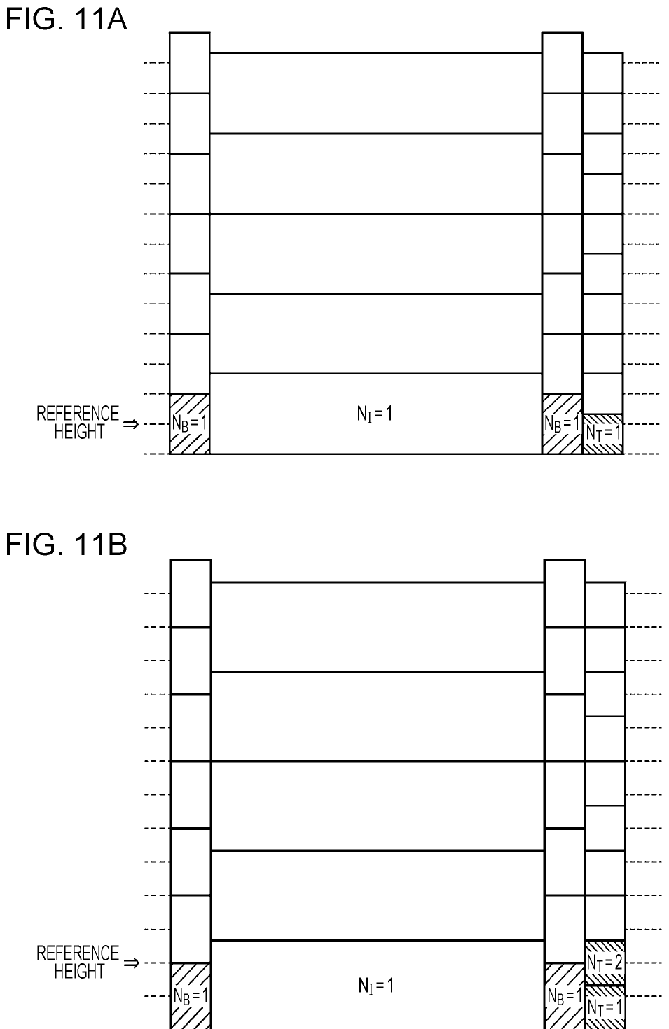

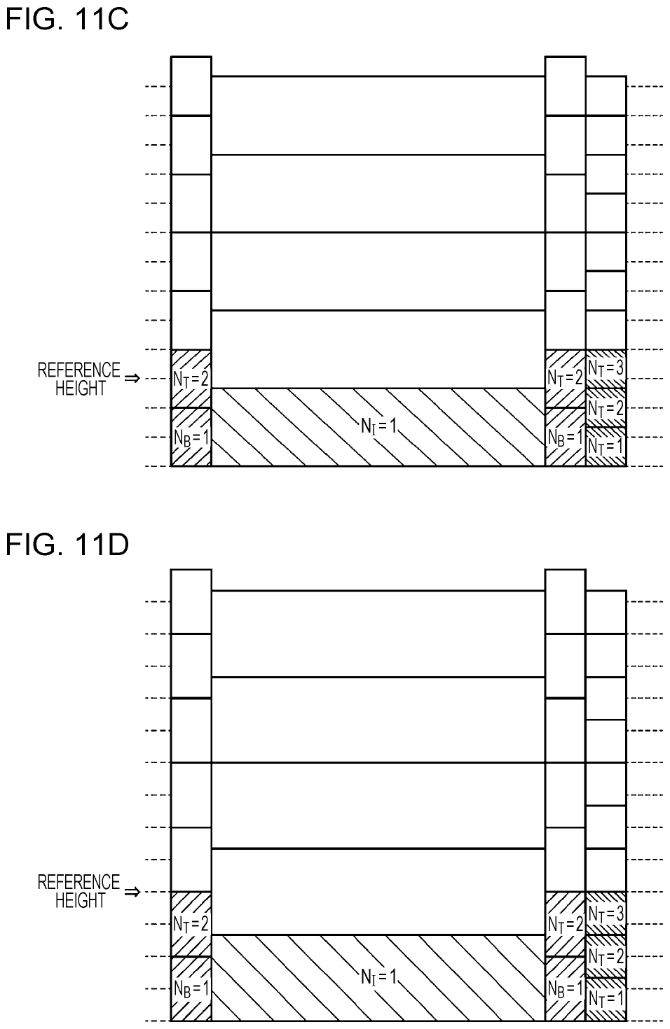

FIG. 11A to FIG. 11D are views for explaining a flow to determine an order of formation of layers. A description is given using the same example as in FIG. 10, and division of passes of layers in a width direction (X-direction) is omitted. The process is performed in the order from FIG. 11A to FIG. 11D. At the time of the start, the order of formation is not determined for the layers of any region.

FIG. 11A shows a case where the reference height is H_{L}. At this point, first, the first layer (N_{B}=1) of the outer edge portion of the solid rectangular prism, the first layer (N_{I}=1) of the inner filled portion of the solid rectangular prism, and the first layer (N_{T}=1) of the thin plate are extracted as formation candidates. In this situation, if the first layer of the inner filled portion of the solid rectangular prism is formed, the height exceeds the lamination height of the first layer of the outer edge portion, thus the first layer of the inner filled portion of the solid rectangular prism is excluded from the formation candidates, and its formation is halted. As a result, the first layer (N_{B}=1) of the outer edge portion of the solid rectangular prism, and the first layer (N_{T}=1) of the thin plate are determined to be formed, and their order of formation is determined. The order of formation here of the first layer of the outer edge portion of the solid rectangular prism and the first layer of the thin plate may be determined in accordance with predetermined rules.

FIG. 11B shows a case where the reference height is 2H_{L}. At this point, first, the first layer (N_{I}=1) of the inner filled portion of the solid rectangular prism, and the second layer (N_{T}=2) of the thin plate are extracted as formation candidates. In this situation, if the first layer of the inner filled portion of the solid rectangular prism is formed, the height exceeds the lamination height of the first layer of the outer edge portion, thus the first layer of the inner filled portion of the solid rectangular prism is excluded from the formation candidates, and its formation is halted. As a result, the second layer (N_{T}=2) of the thin plate is determined to be formed, and the order of formation determined in FIG. 11A is followed.

FIG. 11C shows a case where the reference height is 3H_{L}. At this point, first, the second layer (N_{B}=2) of the outer edge portion of the solid rectangular prism, the first layer (N_{I}=1) of the inner filled portion of the solid rectangular prism, and the third layer (N_{T}=3) of the thin plate are extracted as formation candidates. In this situation, if the first layer of the inner filled portion of the solid rectangular prism is formed, the height exceeds the lamination height of the first layer of the outer edge portion, but is lower than the lamination height of the second layer of the outer edge portion which is a formation candidate. Thus, the first layer of the inner filled portion of the solid rectangular prism is not excluded from the formation candidates, and the second layer (N_{B}=2) of the outer edge portion of the solid rectangular prism, the first layer (N_{I}=1) of the inner filled portion of the solid rectangular prism, and the third layer (N_{T}=3) of the thin plate are determined to be formed. In this situation, the first layer of the inner filled portion of the solid rectangular prism is determined to be formed later than the formation of the second layer of the outer edge portion which is a formation candidate. The order of formation here of the second layer of the outer edge portion of the solid rectangular prism and the third layer of the thin plate may be determined in accordance with predetermined rules.

FIG. 11D shows a case where the reference height is 4H_{L}. At this point, first, the second layer (N_{I}=2) of the inner filled portion of the solid rectangular prism is extracted as a formation candidate. In this situation, if the second layer of the inner filled portion of the solid rectangular prism is formed, the height exceeds the lamination height of the second layer of the outer edge portion, thus the first layer of the inner filled portion of the solid rectangular prism is excluded from the formation candidates, and its formation is halted. As a result, at this point, the order of formation of any layer is not determined. The order of formation of all layers of the element shapes is determined by repeating the above-described process.

### [Formation Order Determination Process]

FIG. 12 is a flowchart of a formation order determination process according to this embodiment, and corresponds to the process executed in step S303 of the entire flow shown in FIG. 3. This process may be implemented, for example, by a processor such as a CPU and a GPU reading and executing a program from an unillustrated storage device to achieve each unit shown in FIG. 2, the processor being included in the modeling control device 2.

As shown in FIG. 10, an example is illustrated in which the additively manufactured object W is constituted by element shapes of a solid rectangular prism and a thin plate. Therefore, the process steps and the determination steps are increased or decreased in number according to the combination of the element shapes constituting the additively manufactured object W. The process shown in FIG. 12 is executed by the lamination pattern setting unit 16 and the formation order adjustment unit 17 shown in FIG. 2 referring to each DB managed in the storage 11. Here, in order to simplify a description, the agents of the process are collectively referred to as the modeling control device 2.

In S1201, the modeling control device 2 refers to the lamination pattern DB 14 to obtain a lamination pattern corresponding to each of the plurality of element shapes disassembled in S302 of FIG. 3. In this example, a lamination pattern for each of the solid rectangular prism and the thin plate is obtained.

In S1202, the modeling control device 2 sets a pass height corresponding to each region of an extracted shape based on the lamination pattern obtained in S1201. As described using FIG. 9, in this example, the modeling control device 2 sets the pass height H_{B} of the outer edge portion of the solid rectangular prism, the pass height H_{I} of the inner filled portion, and the pass height H_{T} of the thin plate.

In S1203, the modeling control device 2 sets the unit height H_{L}. As described above, the unit height H_{L} is a unit serving as a reference when determining the order of formation of beads. The order of formation of beads is determined for each height (hereinafter referred to as the “reference height”) of integral multiple of the unit height H_{L}. The unit height H_{L} is assumed to be predetermined, and held in the storage 11. Note that a constant value may be used as the unit height H_{L}, or a different value may be used according to the combination of the element shapes constituting the additively manufactured object W.

In S1204, the modeling control device 2 initializes the variable n to 0, and sets the reference height (=n×H_{L}).

In S1205, the modeling control device 2 initializes a variable which indicates the number of layers of each extracted shape. In this example, variable N_{B} indicating the number of layers of the outer edge portion of the solid rectangular prism, variable N_{I} indicating the number of layers of the inner filled portion of the solid rectangular prism, and variable N_{T} indicating the number of layers of the thin plate are each initialized to 0. In the following description, H(N) indicates the lamination height of the Nth layer, and the subscript indicates the position of the region. For example, H_{B}(N_{B}) indicates the lamination height of the Nth layer of the outer edge portion. Also, P(N) indicates the pass of the Nth layer, and the subscript indicates the position of the region. For example, P_{B}(N_{B}) indicates the pass of the Nth layer of the outer edge portion.

In S1206, the modeling control device 2 sets an upper limit of the number of layers of each extracted shape based on the model shape data and each pass height set in S1202. In this example, an upper limit N_{B}_max of the number of layers of the outer edge portion of the solid rectangular prism, an upper limit N_{I}_max of the number of layers of the inner filled portion of the solid rectangular prism, and an upper limit N_{T}_max of the number of layers of the thin plate are set. In the case of the example of FIG. 10, N_{B}_max=7, N_{I}_max=5, and N_{T}_max=10.

In S1207, the modeling control device 2 initializes the list of formation candidates.

In S1208, the modeling control device 2 determines whether N_{B} N_{B}_max. When N_{B}=N_{B}_max (YES in S1208), the process of the modeling control device 2 proceeds to S1211. In contrast, when N_{B}=N_{B}_max is false (NO in S1208), the process of the modeling control device 2 proceeds to S1209.

In S1209, the modeling control device 2 determines whether the reference height>H_{B}(N_{B}). When the reference height>H_{B}(N_{B}) (YES in S1209), the process of the modeling control device 2 proceeds to S1210. In contrast, when the reference height>H_{B}(N_{B}) is false (NO in S1209), the process of the modeling control device 2 proceeds to S1211.

In S1210, the modeling control device 2 sets P_{B}(N_{B}+1) as a formation candidate.

In S1211, the modeling control device 2 determines whether N_{I}=N_{I}_max. When N_{I}=N_{I}_max (YES in S1211), the process of the modeling control device 2 proceeds to S1214. In contrast, when N_{I}=N_{I}_max is false (NO in S1211), the process of the modeling control device 2 proceeds to S1212.

In S1212, the modeling control device 2 determines whether the reference height>H_{I}(N_{I}). When the reference height>H_{I}(N_{I}) (YES in S1212), the process of the modeling control device 2 proceeds to S1213. In contrast, when the reference height>H_{I}(N_{I}) is false (NO in S1212), the process of the modeling control device 2 proceeds to S1214.

In S1213, the modeling control device 2 sets P_{I}(N_{I}+1) as a formation candidate.

In S1214, the modeling control device 2 determines whether N_{T}=N_{T}_max. When N_{T}=N_{T}_max (YES in S1214), the process of the modeling control device 2 proceeds to S1217. In contrast, when N_{T}=N_{T}_max is false (NO in S1214), the process of the modeling control device 2 proceeds to S1215.

In S1215, the modeling control device 2 determines whether the reference height>H_{T}(N_{T}). When the reference height>H_{T}(N_{T}) (YES in S1215), the process of the modeling control device 2 proceeds to S1216. In contrast, when the reference height>H_{T}(N_{T}) is false (NO in S1215), the process of the modeling control device 2 proceeds to S1217.

In S1216, the modeling control device 2 sets P_{T}(N_{T}+1) as a formation candidate. Note that the order of the processes in S1208 to S1210 (corresponding to the outer edge portion of the solid rectangular prism), the processes in S1211 to S1213 (corresponding to the inner filled portion of the solid rectangular prism), and the processes in S1214 to S1216 (corresponding to the thin plate) is not limited to this, and the order of these processes may be changed.

In S1217, the modeling control device 2 determines whether both P_{B}(N_{B}+1) and P_{I}(N_{I}+1) are included in the formation candidates. When both are included (YES in S1217), the process of the modeling control device 2 proceeds to S1220. In contrast, when either one of them is not included (NO in S1217), the process of the modeling control device 2 proceeds to S1218.

In S1218, the modeling control device 2 determines whether P_{I}(N_{I}+1) is included in the formation candidates. When P_{I}(N_{I}+1) is included (YES in S1218), the process of the modeling control device 2 proceeds to S1219. In contrast, when P_{I}(N_{I}+1) is not included (NO in S1218), the process of the modeling control device 2 proceeds to S1222.

In S1219, the modeling control device 2 determines whether H_{B}(N_{B})<H_{I}(N_{I}+1). When H_{B}(N_{B})<H_{I}(N_{I}+1) (YES in S1219), the process of the modeling control device 2 proceeds to S1221. In contrast, when H_{B}(N_{B})<H_{I}(N_{I}+1) is false (NO in S1219), the process of the modeling control device 2 proceeds to S1222.

In S1220, the modeling control device 2 determines whether H_{B}(N_{B}+1)<H_{I}(N_{I}+1). When H_{B}(N_{B}+1)<H_{I}(N_{I}+1) (YES in S1220), the process of the modeling control device 2 proceeds to S1221. In contrast, when H_{B}(N_{B}+1)<H_{I}(N_{I}+1) is false (NO in S1220), the process of the modeling control device 2 proceeds to S1222.

In S1221, the modeling control device 2 excludes P_{I}(N_{I}+1) from the formation candidates.

In S1222, the modeling control device 2 determines the order of formation of the passes included in the formation candidates. The order of formation here may be determined according to the priority set for each position type of the element shape, or may be determined based on the order defined according to the combination of element shapes. In relation to this, when an inner filled portion is included in the formation candidates, the inner filled portion is preferably formed later than the formation of the outer edge portion.

In S1223, the modeling control device 2 increments the value of the number of layers included in the formation candidates by one. Specifically, when P_{B}(3) is included in the formation candidates, since the value of N_{B} is 2 (=3−1), the value of N_{B} is updated to 3 by adding 1 thereto. This means that the order of formation is determined up to the third layer of the outer edge portion.

In S1224, the modeling control device 2 determines whether the order of formation of all the layers for each extracted shape has been determined. In this example, it is determined whether N_{B}=N_{B}_max, N_{I}=N_{I}_max, N_{T}=N_{T}_max. When the order of formation of all the layers is determined (YES in S1224), the process flow is completed. However, when the order of formation is not determined for a layer (NO in S1224), the process of the modeling control device 2 proceeds to S1225.

In S1225, the modeling control device 2 updates the reference height (n×H_{L}) by incrementing the value of n by one. The process of the modeling control device 2 then returns to S1207, and repeats the subsequent processes.

A program group to control the manipulator 3 and the heat source control device 6 is generated based on the order of formation determined by the above-described process flow. The control parameter here can be set based on the lamination pattern defined in the lamination pattern DB 14.

Thus, in this embodiment, when an additively manufactured object is modeled, it is possible to improve the construction efficiency of the entire additively manufactured object while reducing the occurrence of a welding defect in a region which requires mechanical properties.

Note that in the above, the lamination height of the outer edge portion is compared with the lamination height of the inner filled portion, and the order of formation of layers is determined so that the outer edge portion has a higher lamination height. In relation to this, it is more preferable that the height difference between the lamination heights be in a predetermined range. The predetermined range is not particularly limited, but may be determined based on the difference between the respective amounts of welding of the outer edge portion and the inner filled portion which are defined in a lamination pattern. Alternatively, the height difference between the lamination height of the outer edge portion and the lamination height of the inner filled portion may be controlled so as not to exceed a predetermined range by adjusting the value of the unit height H_{L} based on the difference between the respective amounts of welding of the outer edge portion and the inner filled portion which are defined in a lamination pattern. Also, a predetermined range for the height difference may be set according to the wire extension from the torch 8. For example, when the wire extension is assumed to be 12 to 15 mm, it is preferable that the height difference be less than or equal to 20 mm. More preferably, the height difference is less than or equal to 15 mm, and further preferably, the height difference is less than or equal to 12 mm. With the above setting, it is possible to prevent burn-through of the outer edge portion, and interference of the torch 8 with the additively manufactured object W.

### Second Embodiment

As a second embodiment of the present invention, a case where element shapes share an outer edge portion and a case where passes cross in an additively manufactured object will be described. Note that the description of features in common with the first embodiment is omitted, and a description is given with a focus on different features.

### [Pass Crossing]

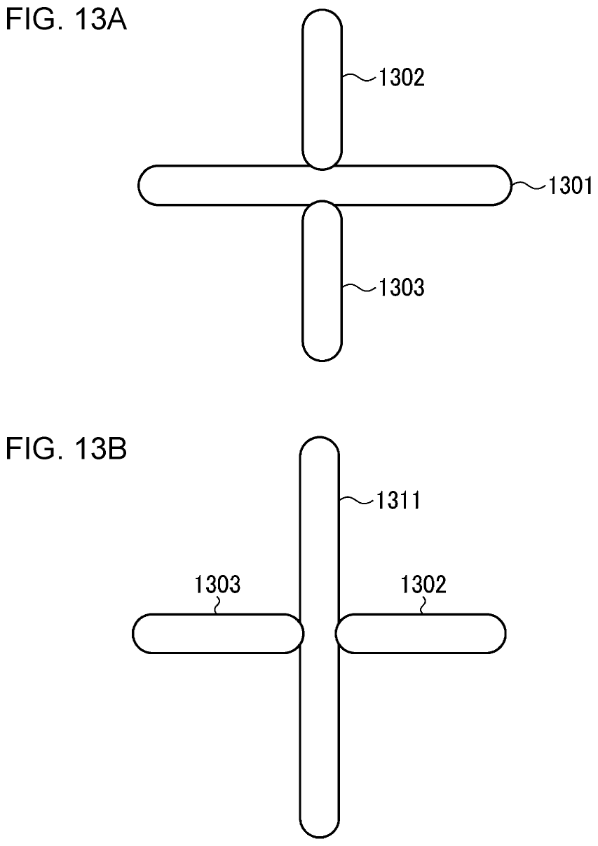

FIG. 13A, FIG. 13B are illustrations for explaining crossing of passes when forming element shapes according to this embodiment, and show an example of a view of a region constituted by thin plates illustrated in FIG. 4 in a lamination direction. When bead is formed with passes crossed, a crossing portion increases in thickness. For example, the height or width of a crossing portion differs from that of other portions. For this reason, at a position where passes cross, formation of bead on a subsequent pass is once stopped at a cross portion with a preceding pass, and formation of bead is resumed at a position passing the cross portion. FIG. 13A shows an example in which a pass 1301 in a horizontal direction is set as a preceding pass, then passes 1302, 1303 in a vertical direction are each set as a subsequent pass. In contrast, FIG. 13B shows an example in which a pass 1311 in a vertical direction is set as a preceding pass, then passes 1302, 1303 in a horizontal direction are each set as a subsequent pass. In this embodiment, in a configuration in which crossing of passes occurs, a formation path and the order of formation are determined based on the conditions as described above.

When such crossing of passes occurs, in order to stabilize the shape after modeling, it is preferable that passes forming beads be alternately formed as a preceding pass and a subsequent pass. Specifically, lamination is preferably performed in the order of passes in FIG. 13A and the order of passes in FIG. 13B alternately. Note that the alternate lamination herein is not limited to one layer by one layer, and may be performed every predetermined number of layers (for example, two layers), or may be adjusted according to other regions and element shapes positioned in the periphery.

### [Pass Sharing]

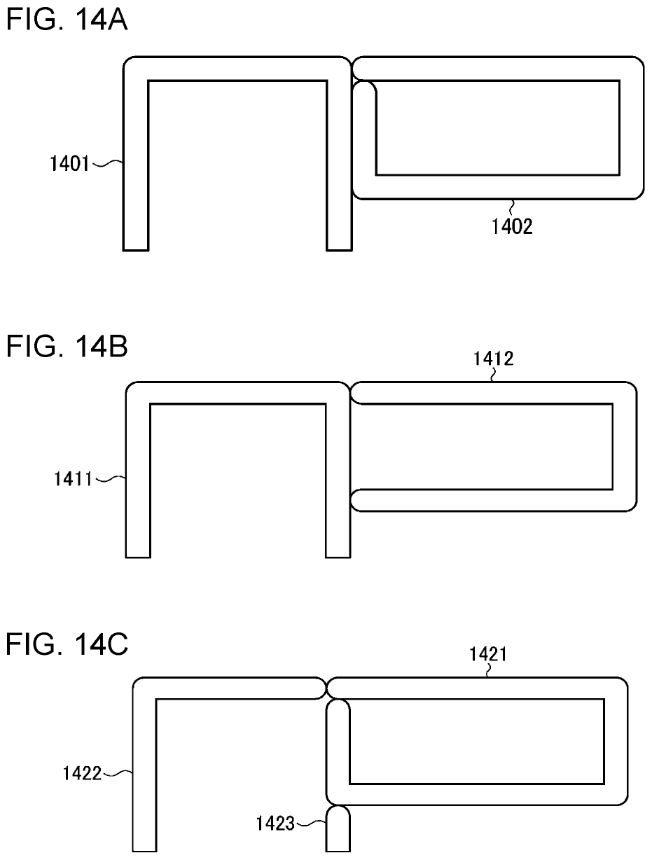

FIG. 14A, FIG. 14B, FIG. 14C are illustrations for explaining sharing of a pass when element shapes according this embodiment are formed, and each show an example of a view of the region formed by solid rectangular prisms shown in FIG. 4 in a lamination direction. When one additively manufactured object is disassembled into a plurality of element shapes, their connection portion may be configured to have passes in common. For example, when two solid rectangular prisms are extracted from the shape shown in FIG. 4, disassembly can be made as in FIG. 14A. In this situation, the two solid rectangular prisms are connected at their outer edge portions 1401, 1402. Sharing this connection portion as one outer edge portion can improve the construction efficiency. Specifically, as shown in FIG. 14B and FIG. 14C, at the connection portion, one of the passes remains to be an outer edge portion, and the other of the passes is replaced by an inner filled portion.

FIG. 14B shows an example in which a pass 1411 is set as a preceding pass, and a pass 1412 is set as a subsequent pass. In contrast, FIG. 14C shows an example in which a pass 1421 is set as a preceding pass, and passes 1422, 1423 are each set as a subsequent pass. Consequently, the range of the outer edge portion is reduced, and the efficiency of lamination can be improved by forming an inner filled portion which allows a deposition rate to increase higher than that of the outer edge portion. In FIG. 14C, start and end positions of a pass are arranged in a shared portion; however, without being limited to this, start and end positions may be arranged in a non-shared portion.

When such sharing of a pass occurs, in order to stabilize the shape after modeling, it is preferable that passes forming beads be alternately formed as a preceding pass and a subsequent pass. Specifically, lamination is preferably performed in the order of passes in FIG. 14B and the order of passes in FIG. 14C alternately. Note that the alternate lamination herein is not limited to one layer by one layer, and may be performed every predetermined number of layers (for example, two layers), or may be adjusted according to other regions and element shapes positioned in the periphery.

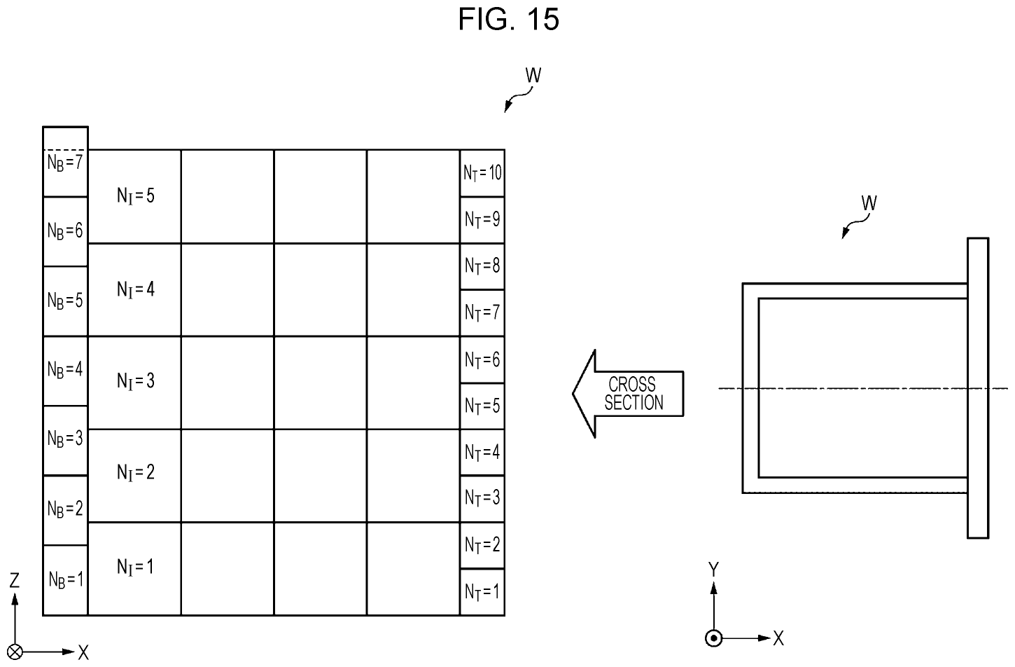

FIG. 15 is a view for explaining a concept for determining the order of formation of layers for the plurality of element shapes constituting the additively manufactured object W when pass sharing occurs. As the difference from the configuration described using FIG. 10 in the first embodiment, at the connection portion between a solid rectangular prism and a thin plate, the outer edge portion of the solid rectangular prism is replaced by the inner filled portion. Other configurations are the same those described using FIG. 10.

### [Process Flow]

### (Formation Order Determination Process)

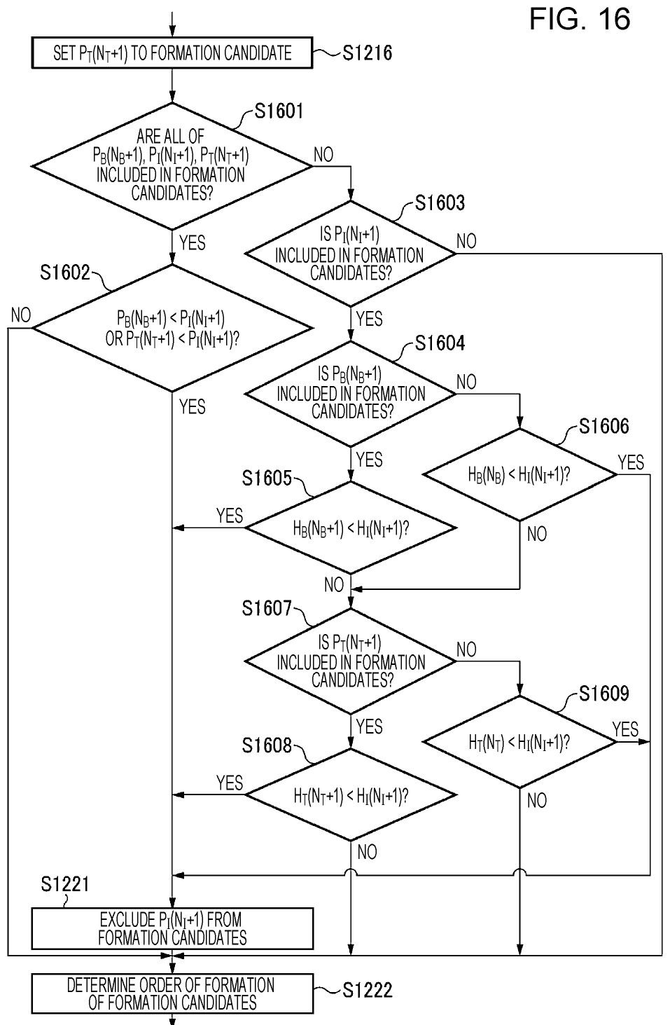

FIG. 16 is a flowchart of a formation order determination process according to this embodiment, and the formation order determination process is performed in replacement of steps of S1217 to S1220 of the processes shown in FIG. 12 in the first embodiment. As shown in FIG. 15, an instance is illustrated in which the additively manufactured object W is constituted by element shapes of a solid rectangular prism and a thin plate. Therefore, the process steps and the determination steps are increased or decreased in number according to the combination of the element shapes constituting the additively manufactured object W. The process shown in FIG. 16 is executed by the lamination pattern setting unit 16 and the formation order adjustment unit 17 shown in FIG. 2 referring to each DB managed in the storage 11. Here, in order to simplify a description, the agents of the process are collectively referred to as the modeling control device 2.

After the process in S1216, the process of the modeling control device 2 proceeds to S1601. In S1601, the modeling control device 2 determines whether all of the P_{B}(N_{B}+1), P_{I}(N_{I}+1), and P_{T}(N_{T}+1) are included in the formation candidates. When all of them are included (YES in S1601), the process of the modeling control device 2 proceeds to S1602. In contrast, when either one of them is not included (NO in S1601), the process of the modeling control device 2 proceeds to S1603.

In S1602, the modeling control device 2 determines whether H_{B}(N_{B}+1)<H_{I}(N_{I}+1) or H_{T}(N_{T}+1)<H_{I}(N_{I}+1). In other words, it is determined whether the lamination height of P_{I}(N_{I}+1) which is a formation candidate is higher than the lamination height of other formation candidates. When this condition is met (YES in S1602), the process of the modeling control device 2 proceeds to S1221. In contrast, when this condition is not met (NO in S1602), the process of the modeling control device 2 proceeds to S1222.

In S1603, the modeling control device 2 determines whether P_{I}(N_{I}+1) is included in the formation candidates. When P_{I}(N_{I}+1) is included (YES in S1603), the process of the modeling control device 2 proceeds to S1604. In contrast, when P_{I}(N_{I}+1) is not included (NO in S1603), the process of the modeling control device 2 proceeds to S1222.

In S1604, the modeling control device 2 determines whether P_{B}(N_{B}+1) is included in the formation candidates. When P_{B}(N_{B}+1) is included (YES in S1604), the process of the modeling control device 2 proceeds to S1605. In contrast, when P_{B}(N_{B}+1) is not included (NO in S1604), the process of the modeling control device 2 proceeds to S1606.

In S1605, the modeling control device 2 determines whether H_{B}(N_{B}+1)<H_{I}(N_{I}+1). When H_{B}(N_{B}+1)<H_{I}(N_{I}+1) (YES in S1605), the process of the modeling control device 2 proceeds to S1221. In contrast, when H_{B}(N_{B}+1)<H_{I}(N_{I}+1) is false (NO in S1605), the process of the modeling control device 2 proceeds to S1607.

In S1606, the modeling control device 2 determines whether H_{B}(N_{B})<H_{I}(N_{I}+1). When H_{B}(N_{B})<H_{I}(N_{I}+1) (YES in S1606), the process of the modeling control device 2 proceeds to S1221. In contrast, when H_{B}(N_{B})<H_{I}(N_{I}+1) is false (NO in S1606), the process of the modeling control device 2 proceeds to S1607.

In S1607, the modeling control device 2 determines whether P_{T}(N_{T}+1) is included in the formation candidates. When P_{T}(N_{T}+1) is included (YES in S1607), the process of the modeling control device 2 proceeds to S1608. In contrast, when P_{T}(N_{T}+1) is not included (NO in S1607), the process of the modeling control device 2 proceeds to S1609.

In S1608, the modeling control device 2 determines whether H_{T}(N_{T}+1)<H_{I}(N_{I}+1). When H_{T}(N_{T}+1)<H_{I}(N_{I}+1) (YES in S1608), the process of the modeling control device 2 proceeds to S1221. In contrast, when H_{T}(N_{T}+1)<H_{I}(N_{I}+1) is false (NO in S1608), the process of the modeling control device 2 proceeds to S1222.

In S1609, the modeling control device 2 determines whether H_{T}(N_{T})<H_{I}(N_{I}+1). When H_{T}(N_{T})<H_{I}(N_{I}+1) (YES in S1609), the process of the modeling control device 2 proceeds to S1221. In contrast, when H_{T}(N_{T})<H_{I}(N_{I}+1) is false (NO in S1609), the process of the modeling control device 2 proceeds to S1222. Note that the order of the processes in S1604 to S1606 (comparison between the lamination heights of the outer edge portion and the inner filled portion), and the processes in S1607 to S1609 (comparison between the lamination heights of the thin plate and the inner filled portion) is not limited to this, and the order may be reversed.

### [Modification of Pass Sharing]

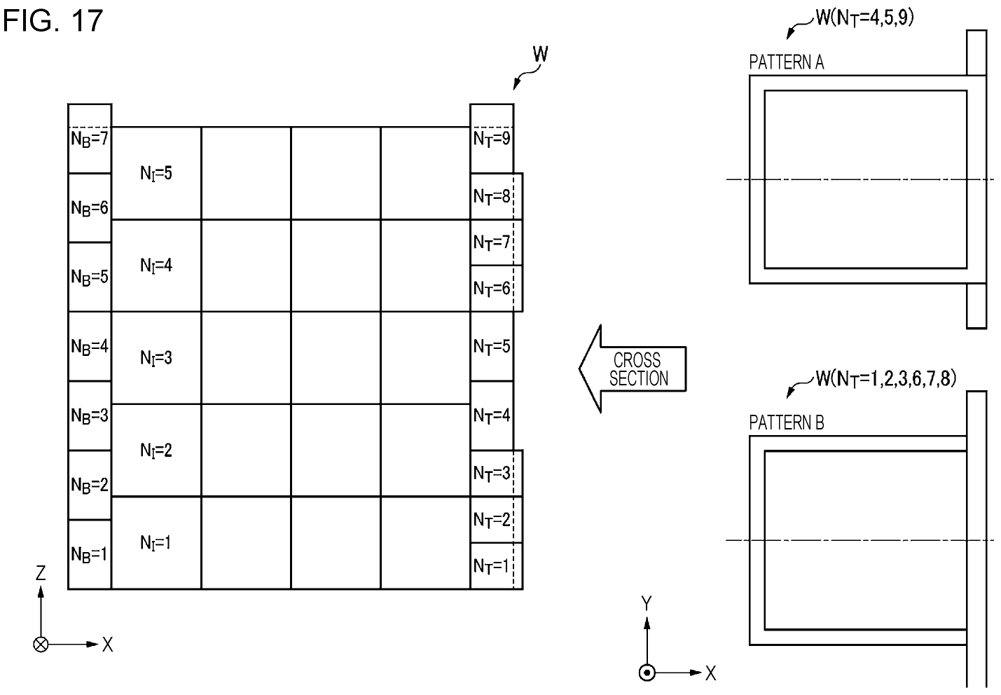

When a pass is shared as described above, an example of alternate formation of beads is shown in FIG. 17. Here, a description is given assuming that the pass heights are set to have a relationship of H_{B}:H_{I}:H_{T}=4:3:2 as an example. As shown in FIG. 17, patterns (formation paths) for lamination can be replaced according to the pass heights of regions. Note that the dashed line shows the shape of the additively manufactured object W indicated by the model shape data. In this example, for the fourth layer, the fifth layer, the ninth layer of the thin plate, passes are set to achieve the pattern A shown in FIG. 17, whereas for the first to third layers, the sixth to eighth layers, passes are set to achieve the pattern B shown in FIG. 17.

When the outer edge portion and the thin plate are different in size in a width direction (X-axis direction) as shown in FIG. 17, whether patterns are replaced may be determined based on whether it is possible to perform a cut process for a portion with a different size. Also, when a layer with a larger size is formed on an upper layer side like the fifth layer (N_{T}=5) and the sixth layer (N_{T}=6) of the thin plate, whether patterns are replaced may be determined under the condition that poor weld such as dripping of bead does not occur at the time of forming an upper layer.

Thus, in addition to the effect of the first embodiment, this embodiment enables the construction efficiency to be further improved in an additively manufactured object in which pass sharing is made.

### Other Embodiments

The present invention is also feasible by a process of supplying a program and/or an application to implement the functions of one or more embodiments described above to a system or a device using a network or a storage medium, and reading and executing the program by one or more processors in a computer of the system or the device.

Alternatively, the invention may be implemented by a circuit that implements one or more functions. Note that the circuit that implements one or more functions includes, for example, ASIC (Application Specific Integrated Circuit) and FPGA (Field Programmable Gate Array).

As stated above, the following matters are disclosed in the present specification.
(1) A modeling condition setting method for performing additive manufacturing of an object using a directional heat source based on model shape data of the object, the method comprising:
a setting step for setting a lamination pattern for each of an outer edge portion and an inner portion in a shape indicated by the model shape data; and
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

With this configuration, modeling conditions can be appropriately set according to the regions constituting an additively manufactured object and the formation situation in the periphery.

Particularly, it is possible to reduce welding defect according to the region in an additively manufactured object.
(2) The setting method according to (1),
wherein the predetermined angle is set according to a configuration of the heat source.

With this configuration, the inclination angle can be controlled according to the configuration of a heat source, such as the wire extension and the size of the device, and interference between a model object already formed and a device such as a nozzle can be reduced.

The device herein refers to a shield nozzle or the like, for example, when a consumable electrode welding method such as carbon dioxide arc welding is used, and refers to a wire feeding device in addition to a torch when a non-consumable electrode welding method such as TIG welding is used.
In addition, for example, in the case of laser welding, the device refers to a light collection head and a mirror system for heat source angle setting.
(3) The setting method according to (1) or (2),
wherein in the setting step, setting is made so that following holds in the lamination pattern for each of the outer edge portion and the inner portion:

aHL=bHB=cHI,
a≠c, b≠c, a>c, b>c, and a≥b,
a, b, c are positive integers,
where H_{B} is a height of one bead of the outer edge portion, H_{I} is a height of one bead of the inner portion, H_{L} is a unit height used to determine an order of formation of beads when each of the outer edge portion and the inner portion is formed by lamination.

With this configuration, the relationship between the sizes of regions is clarified, and the order of formation is easily adjustable.
(4) The setting method according to any one of (1) to (3), further comprising
a disassembly step for disassembling the shape indicated by the model shape data into a plurality of predetermined element shapes,
wherein in the setting step, a lamination pattern is set for an outer edge portion and an inner portion of each of the plurality of element shapes disassembled in the disassembly step.

With this configuration, even an object having a complicated shape can be disassembled into elements having a simple shape, and easily processed.
(5) The setting method according to (4),
wherein in the setting step, when two element shapes are adjacent, a lamination pattern for the two element shapes is set by sharing an outer edge portion of one of the element shapes, and replacing an outer edge portion of the other of the element shapes by an inner portion.

Although a defect is likely to occur when outer edge portions with low heat input are constructed concurrently, with this configuration, it is possible to reduce the occurrence of a defect.
(6) The setting method according to (5),
wherein in the setting step, when two element shapes are adjacent, element shapes for which an outer edge portion is replaced by an inner portion are switched every predetermined number of layers in a lamination direction.

With this configuration, the accuracy of modeling the entire additively manufactured object can be improved without concentration of portions where a welding defect is likely to occur.
(7) The setting method according to (4),
wherein in the setting step, when two element shapes cross, a formation path of the two element shapes is set so that after one of the element shapes is formed, a cross portion is not formed when the other of the element shapes is formed.

With this configuration, in an object having a complicated shape, it is possible to reduce the occurrence of an excessive thickness of the cross portion.
(8) The setting method according to (7),
wherein in the setting step, when two element shapes cross, element shapes for which the cross point is not formed are switched every predetermined number of layers in a lamination direction.

With this configuration, the accuracy of modeling the entire additively manufactured object can be improved without concentration of portions where an abnormal thickness is likely to occur.
(9) An additive manufacturing method for performing additive manufacturing of an object using a directional heat source based on model shape data of the object, the additive manufacturing method comprising:
a setting step for setting a lamination pattern for each of an outer edge portion and an inner portion in a shape indicated by the model shape data;
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated; and
a control step for causing a modeling means to perform additive manufacturing of the object based on the lamination pattern set in the setting step and the order of formation adjusted in the adjustment step,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

With this configuration, modeling conditions can be appropriately set according to the regions constituting an additively manufactured object and the formation situation in the periphery.
(10) An additive manufacturing system for performing additive manufacturing of an object using a directional heat source based on model shape data of the object, the additive manufacturing system comprising:
a setting means to set a lamination pattern for each of an outer edge portion and an inner portion in a shape indicated by the model shape data;
an adjustment means to adjust an order of formation when each of the outer edge portion and the inner portion is formed by lamination using the lamination pattern set by the setting means so that at a time of modeling, a height of the outer edge portion already laminated is higher than a height of the inner portion which is to be newly laminated; and
a modeling means to perform additive manufacturing of the object based on the lamination pattern set by the setting means and the order of formation adjusted by the adjustment means,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

With this configuration, modeling conditions can be appropriately set according to the regions constituting an additively manufactured object and the formation situation in the periphery.
(11) A program for causing a computer to execute:
a setting step for setting a lamination pattern for each of an outer edge portion and an inner portion in a shape indicated by model shape data of an object; and
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated,
wherein in the lamination pattern, an orientation of a heat source when forming a region positioned at a boundary with the outer edge portion is set to be inclined at a predetermined angle with respect to the outer edge portion in a plane perpendicular to a direction of movement of the heat source.

With this configuration, modeling conditions can be appropriately set according to the regions constituting an additively manufactured object and the formation situation in the periphery.

Various embodiments have been described in the above with reference to the drawings. Needless to say, the present invention is not limited to those examples. It is apparent that various modifications and alterations will occur to those skilled in the art within the scope of the appended claims, and it should be understood that those modifications and alterations naturally fall within the technical scope of the present invention. In a range without departing from the spirit of the invention, the components in the above embodiments may be combined in any manner.

The present application is based on Japanese Patent Application (No. 2020-161260) filed on Sep. 25, 2020, the entire contents of which are incorporated herein by reference.

### REFERENCE SIGNS LIST

1 additive manufacturing system
2 modeling control device
3 manipulator
4 manipulator control device
controller
6 heat source control device
7 base
8 torch
10 input unit
11 storage
12 model shape data
13 element shape DB (database)
14 lamination pattern DB (database)
15 element shape disassembly unit
16 lamination pattern setting unit
17 formation order adjustment unit
18 program generation unit
19 output unit
W additively manufactured object

1. A modeling condition setting method for performing additive manufacturing of an object using a directional heat source based on model shape data of the object, the method comprising:
a setting step for setting a lamination pattern for each of an outer edge portion and an inner portion in a shape indicated by the model shape data; and
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

2. The setting method according to claim 1,
wherein the predetermined angle is set according to a configuration of the heat source.

3. The setting method according to claim 1,
wherein in the setting step, setting is made so that following holds in the lamination pattern for each of the outer edge portion and the inner portion:
aH_{L}=bH_{B}=cH_{I},
a≠c, b≠c, a>c, b>c, and a≥b,
a, b, c are positive integers,
where H_{B} is a height of one bead of the outer edge portion, H_{I} is a height of one bead of the inner portion, H_{L} is a unit height used to determine an order of formation of beads when each of the outer edge portion and the inner portion is formed by lamination.

4. The setting method according to claim 1, further comprising
a disassembly step for disassembling the shape indicated by the model shape data into a plurality of predetermined element shapes,
wherein in the setting step, a lamination pattern is set for an outer edge portion and an inner portion of each of the plurality of element shapes disassembled in the disassembly step.

5. The setting method according to claim 3, further comprising
a disassembly step for disassembling the shape indicated by the model shape data into a plurality of predetermined element shapes,
wherein in the setting step, a lamination pattern is set for an outer edge portion and an inner portion of each of the plurality of element shapes disassembled in the disassembly step.

6. The setting method according to claim 4,
wherein in the setting step, when two element shapes are adjacent, a lamination pattern for the two element shapes is set by sharing an outer edge portion of one of the element shapes, and replacing an outer edge portion of the other of the element shapes by an inner portion.

7. The setting method according to claim 5,
wherein in the setting step, when two element shapes are adjacent, a lamination pattern for the two element shapes is set by sharing an outer edge portion of one of the element shapes, and replacing an outer edge portion of the other of the element shapes by an inner portion.

8. The setting method according to claim 6,
wherein in the setting step, when two element shapes are adjacent, element shapes for which an outer edge portion is replaced by an inner portion are switched every predetermined number of layers in a lamination direction.

9. The setting method according to claim 7,
wherein in the setting step, when two element shapes are adjacent, element shapes for which an outer edge portion is replaced by an inner portion are switched every predetermined number of layers in a lamination direction.

10. The setting method according to claim 4,
wherein in the setting step, when two element shapes cross, a formation path of the two element shapes is set so that after one of the element shapes is formed, a cross portion is not formed when the other of the element shapes is formed.

11. The setting method according to claim 5,
wherein in the setting step, when two element shapes cross, a formation path of the two element shapes is set so that after one of the element shapes is formed, a cross portion is not formed when the other of the element shapes is formed.

12. The setting method according to claim 10,
wherein in the setting step, when two element shapes cross, element shapes for which the cross point is not formed are switched every predetermined number of layers in a lamination direction.

13. The setting method according to claim 11,
wherein in the setting step, when two element shapes cross, element shapes for which the cross point is not formed are switched every predetermined number of layers in a lamination direction.

14. An additive manufacturing method for performing additive manufacturing of an object using a directional heat source based on model shape data of the object, the additive manufacturing method comprising:
a setting step for setting a lamination pattern for each of an outer edge portion and an inner portion in a shape indicated by the model shape data;
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated; and
a control step for causing a modeling means to perform additive manufacturing of the object based on the lamination pattern set in the setting step and the order of formation adjusted in the adjustment step,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

15. An additive manufacturing system for performing additive manufacturing of an object using a directional heat source based on model shape data of the object, the additive manufacturing system comprising:
a setting means to set a lamination pattern for each of an outer edge portion and an inner portion in a shape indicated by the model shape data;
an adjustment means to adjust an order of formation when each of the outer edge portion and the inner portion is formed by lamination using the lamination pattern set by the setting means so that at a time of modeling, a height of the outer edge portion already laminated is higher than a height of the inner portion which is to be newly laminated; and
a modeling means to perform additive manufacturing of the object based on the lamination pattern set by the setting means and the order of formation adjusted by the adjustment means,
wherein in the lamination pattern, an orientation of the heat source when forming a region positioned at a boundary with the outer edge portion is set to be inclined at a predetermined angle with respect to the outer edge portion in a plane perpendicular to a direction of movement of the heat source.

16. A program for causing a computer to execute:
a setting step for setting a lamination pattern for each of an outer edge portion and an inner portion in a shape indicated by model shape data of an object; and
an adjustment step for adjusting an order of formation when each of the outer edge portion and the inner portion is formed by lamination using the lamination pattern set in the setting step so that at a time of modeling, a height of the outer edge portion already laminated is higher than a height of the inner portion which is to be newly laminated,
wherein in the lamination pattern, an orientation of a heat source when forming a region positioned at a boundary with the outer edge portion is set to be inclined at a predetermined angle with respect to the outer edge portion in a plane perpendicular to a direction of movement of the heat source.
